(19) United States
(12) Patent Application Publication
(10) Pub. No.: US 2025/0330262 A1
(43) Pub. Date: Oct. 23, 2025

(54) ELECTRONIC DEVICE AND METHOD OF OPERATING THE ELECTRONIC DEVICE

(71) Applicant: SAMSUNG ELECTRONICS CO., LTD., Suwon-si (KR)

(72) Inventor: BYEOUNG-SU KIM, Suwon-si (KR)

(73) Assignee: SAMSUNG ELECTRONICS CO., LTD., Suwon-si (KR)

(21) Appl. No.: 18/978,812

(22) Filed: Dec. 12, 2024

(30) Foreign Application Priority Data
Apr. 18, 2024 (KR) 10-2024-0052209

(51) Int. Cl. H04L 1/00

(52) U.S. Cl. CPC H04L 1/0033

(57) ABSTRACT

An electronic device and a method of operating the electronic device are provided. The electronic device includes at least one processor configured to receive an input data and perform an encoding operation based on the input data to generate a first latent data, through a first neural network, perform an encoding operation based on the input data to generate a second latent data different from the first latent data, through a second neural network different from the first neural network, and generate an index data corresponding to one of the first latent data and the second latent data, and a communication device configured to transmit the index data and one of the first latent data and the second latent data corresponding to the index data to an external destination.

### CROSS-REFERENCE TO RELATED APPLICATION

This application claims priority to and the benefit of Korean Patent Application No. 10-2024-0052209 filed in the Korean Intellectual Property Office on Apr. 18, 2024, the entire contents of which are incorporated herein by reference.

### BACKGROUND

### 1. Field

The present disclosure relates to an electronic device and a method of operating the electronic device.

### 2. Description of the Related Art

With the advancement of artificial intelligence technology, the artificial intelligence technology is being utilized in various fields such as voice, audio, language, and image processing.

For compression and restoration of voice signals, the code-excited linear prediction (CELP) method is used, and for compression and restoration of audio data, perceptual audio encoding methods based on psychoacoustic models are used.

Additionally, an encoding method for voice signals and audio signals is being proposed based on an autoencoder.

### SUMMARY

One embodiment provides an electronic device and a method of operating the electronic device capable of improving the security of data transmission by making it difficult to analyze data from the outside.

One embodiment provides an electronic device and a method of operating the electronic device that improve operation delay by performing a transmission operation adaptively to the surrounding environment.

According to an aspect of the disclosure, an electronic device may include: at least one processor configured to: receive an input data and perform an encoding operation based on the input data to generate a first latent data, through a first neural network; perform an encoding operation based on the input data to generate a second latent data different from the first latent data, through a second neural network different from the first neural network; and generate an index data corresponding to one of the first latent data and the second latent data; and a communication device configured to transmit the index data and one of the first latent data and the second latent data corresponding to the index data to an external destination

According to another aspect of the disclosure, an electronic device may include: a communication device configured to receive a latent data and an index data corresponding to the latent data; and at least one processor configured to: perform a decoding operation on the latent data to output restored data, through a plurality of neural networks that are different from each other; and select one of the plurality of neural networks based on the index data.

According to another aspect of the disclosure, a method of operating an electronic device may include: selecting a plurality of candidate neural networks from a plurality of neural networks according to predetermined conditions; providing input data to the plurality of candidate neural networks; generating a plurality of latent data for the input data based on the plurality of candidate neural networks; generating index data corresponding to one of the plurality of latent data; and transmitting the index data and one of the plurality of latent data corresponding to the index data to an external destination.

### BRIEF DESCRIPTION OF DRAWINGS

FIG. 1 is a block diagram illustrating an electronic system according to one or more embodiments.

FIG. 2 illustrates an electronic device according to one or more embodiments.

FIGS. 3 and 4 are diagrams for describing an encoder and a decoder according to one or more embodiments.

FIGS. 5 and 6 are schematic views for describing the structure of a neural network (NN) according to one or more embodiments.

FIG. 7 is a flowchart for describing a method of operating an electronic device according to one or more embodiments.

FIGS. 8 to 10 are diagrams for describing a method of operating an electronic device according to one or more embodiments.

FIGS. 11 to 13 are diagrams for describing a method of operating an electronic device according to one or more embodiments.

FIG. 14 is a graph for describing a loss function applied to the learning process of a neural network according to one or more embodiments.

### DETAILED DESCRIPTION

The present disclosure will be described in detail hereinafter with reference to the accompanying drawings, in which embodiments of the present disclosure are shown. As those skilled in the art would realize, the described embodiments may be modified in various different ways, all without departing from the spirit or scope of the present disclosure.

The drawings and description are to be regarded as illustrative in nature and not restrictive, and like reference numerals designate like elements throughout the specification.

In addition, unless explicitly described to the contrary, the word “comprise,” and variations such as “comprises” or “comprising,” will be understood to imply the inclusion of stated elements but not the exclusion of any other elements.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such a phrase should not be understood as a limitation described by the unclear article “one” for the sake of one example.

Furthermore, in those instances where a convention analogous to “at least one of A. B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

In one or more embodiments, “a module,” “a unit,” or “a part” perform at least one function or operation, and may be realized as hardware, such as a processor or integrated circuit, software that is executed by a processor, or a combination thereof. For example, the module may be a procedure executed in a processor, a processor, an object, an execution thread, a program, and/or a computer, but is not limited thereto.

For example, both an application executed in a computing device and the computing device may be modules. One or more modules may reside within a processor and/or an execution thread.

A module may be localized within one computer. A module may be distributed between two or more computers. Further, the components may be executed by various computer readable media having various data structures stored therein. For example, modules may communicate through local and/or remote processing according to a signal (for example, data transmitted to another system through a network, such as Internet, through data and/or a signal from one component interacting with another component in a local system and a distributed system) having one or more data packets.

Throughout the present specification, a nerve network, a network function, and a neural network may be used as the same meaning. The neural network may be formed of a set of connected calculation units, each of which may be generally called a “node”. The “nodes” may also be referred to as “neurons”. The neural network includes two or more nodes. The nodes (or neurons) forming the neural networks may be connected with each other by one or more “links”.

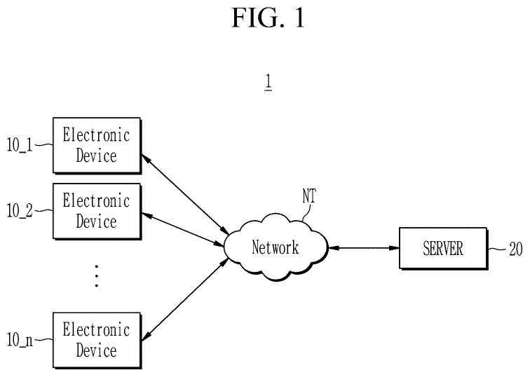

FIG. 1 is a block diagram illustrating an electronic system according to one or more embodiments.

Referring to FIG. 1, an electronic system 1 may include a plurality of electronic devices 10_1-10_n and a server 20. The plurality of electronic devices 10_1, 10_2, . . . , 10_n and the server 20 may communicate with each other through a network NT.

The plurality of electronic devices 10_1, 10_2, . . . , 10_n are terminals capable of transmitting and receiving data and capable of communication, and may be user equipment. In one or more embodiments, the plurality of electronic devices 10_1, 10_2, . . . , 10_n may transmit data to the server 20 along with a request for inference, and the plurality of electronic devices 10_1, 10_2, . . . , 10_n may receive the results of the inference from the server 20. The request for inference may be sent to the server 20 to prompt the server 20 to perform a task to infer or predict using a neural network. Additionally, the plurality of electronic devices 10_1, 10_2, . . . , 10_n may transmit and receive data with each other. In one or more embodiments, the transmitted and received data may be latent data encoded based on an autoencoder.

In addition to the user device, the plurality of electronic devices 10_1, 10_2, . . . , 10_n may be referred to as a terminal, access terminal, mobile terminal, station, subscriber station, mobile station, portable subscriber station, node, device, Internet of Things device, mounted module/device/terminal or on board device/terminal, and the like.

In one or more embodiments, the plurality of electronic devices 10_1, 10_2, . . . , 10_n may include a desktop computer, a laptop computer, a tablet PC, a wireless phone, a mobile phone, and a smart phone, a smart watch, a smart glass, an e-book reader, a portable multimedia player (PMP), a portable game console, a navigation device, a digital camera, a digital multimedia broadcasting (DMB) player, a digital audio recorder, a digital audio player, a digital picture recorder, a digital picture player, a digital video recorder, and a digital video player, but are not limited thereto.

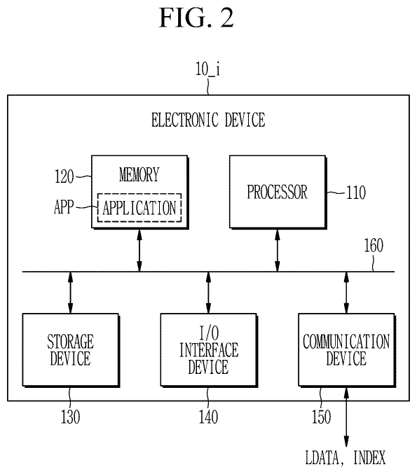

A detailed description of the components included in the plurality of electronic devices 10_1, 10_2, . . . , 10_n may be described later in the description of FIG. 2.

The server 20 may be a facility or a processor that collects various data and provides services. In one or more embodiments, the server 20 may support technologies for a web server, an application server, and a storage server. The server 20 may include electronic devices including a PC server, and may be referred to as an electronic device. In one or more embodiments, the server 20 may transmit and receive data with the plurality of electronic devices 10_1, 10_2, . . . , 10_n. In one or more embodiments, the server 20 may perform an inference operation in accordance with the request and data provided by the plurality of electronic devices 10_1, 10_2, . . . , 10_n, and may provide data on the results of the inference to the plurality of electronic devices 10_1, 10_2, . . . , 10_n. In one or more embodiments, the data may be latent data encoded by an autoencoder encoder.

The server 20 may be a computing system used by a company or government agency that provides cloud computing services, etc., and In one or more embodiments, the server 20 may be a system for operating a search engine and database.

The network NT is a communication network that is a high-speed backbone network of a large communication network capable of high-capacity, long-distance voice and data services, and may mediate data communication between the plurality of electronic devices 10_1, 10_2, . . . , 10_n and the server 20. The network NT may be the Internet or a wired or wireless network to provide high-speed multimedia services.

In one or more embodiments, the network NT may be implemented using Ethernet or the like. In one or more embodiments, the network NT may be a general network such as a TCP/IP network.

In one or more embodiments, the network NT may include a wireless internet such as wireless fidelity (WiFi), a portable internet such as wireless broadband internet (WiBro) or world interoperability for microwave access (WiMax), a 2G mobile communication network such as global system for mobile communication (GSM) or code division multiple access (CDMA), a 3G mobile communication network such as wideband code division multiple access (WCDMA) or CDMA2000, a 3.5G mobile communication network such as high speed downlink packet access (HSDPA) or high speed uplink packet access (HSUPA), a 4G mobile communication network such as long term evolution (LTE) networks or LTE-Advanced networks, a 5G mobile communication network, a B5G mobile communication network (such as a 6G mobile communication network), and the like.

FIG. 2 illustrates an electronic device according to one or more embodiments. An electronic device 10_i of FIG. 2 may be one of the plurality of electronic devices 10_1, 10_2, . . . , 10_n of FIG. 1. The description of the electronic device 10_i below may replace the common description of the plurality of electronic devices 10_1 to 10_n in FIG. 1.

Referring to FIGS. 1 and 2, the electronic device 10_i may include at least one processor 110, a memory 120, a storage device 130, and a communication device (e.g., a communication interface) 150 that is connected to the network NT and performs communication. Additionally, the electronic device 10_i may further include an input/output interface device 140, etc. Each component included in the electronic device 10_i may be connected by a bus 160 and communicate with each other.

In one or more embodiments, each component included in the electronic device 10_i may be connected through an individual interface or individual bus centered on the processor 110, rather than the common bus 160. For example, the processor 110 may be connected to at least one of the memory 120, the storage device 130, the input/output interface device 140, and the communication device 150 through a dedicated interface.

The processor 110 may execute a program by processing program commands and data stored in at least one of the memory 120 and the storage device 130. In one or more embodiments, a program executed in the processor 110 may include an operating system (OS) and an application (APP).

In one or more embodiments, the processor 110 may perform an inference or learning operation for a neural network according to one or more embodiments of the present disclosure, and may perform an operation on at least some layers within the neural network.

The processor 110 may include a general-purpose processor such as an application processor (AP), a central processing unit (CPU), a graphics processing unit (GPU), or may include a dedicated processor for performing an operation method according to one or more embodiments of the present disclosure.

Each of the memory 120 and the storage device 130 may include at least one of a volatile storage medium and a non-volatile storage medium. For example, the memory 120 may include at least one of read only memory (ROM) and random access memory (RAM).

A program executed on the processor 110 may be loaded into the memory 120. In one or more embodiments, the APP executed by the processor 110 may be loaded into the memory 120. In one or more embodiments, instructions and data for an operation method according to one or more embodiments of the present disclosure may be loaded into the memory 120. In one or more embodiments, at least some layers in the neural network according to the embodiment of the present disclosure may be loaded into the memory 120.

The storage device 130 may include at least one storage medium such as flash memory, hard disk, multimedia micro card, card-type memory (such as SD or XD memory), random access memory (RAM), static random access memory (SRAM), read-only memory (ROM), electrically erasable programmable read-only memory (EEPROM), programmable read-only memory (PROM), magnetic memory, magnetic disk, or optical disk.

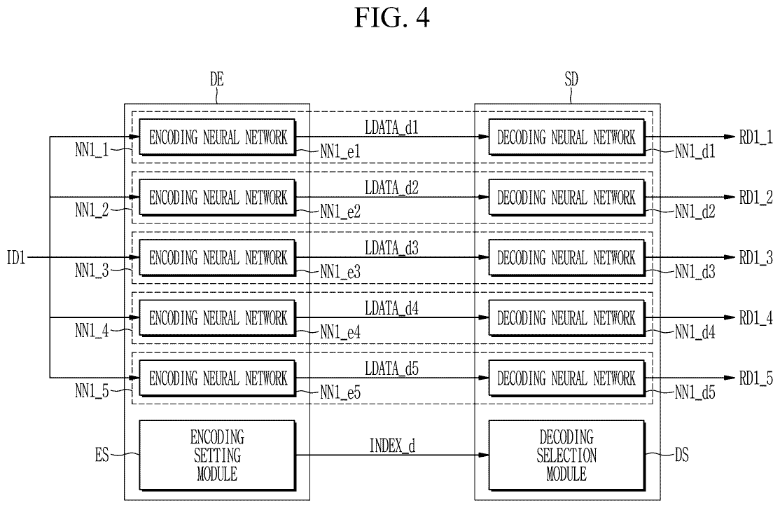

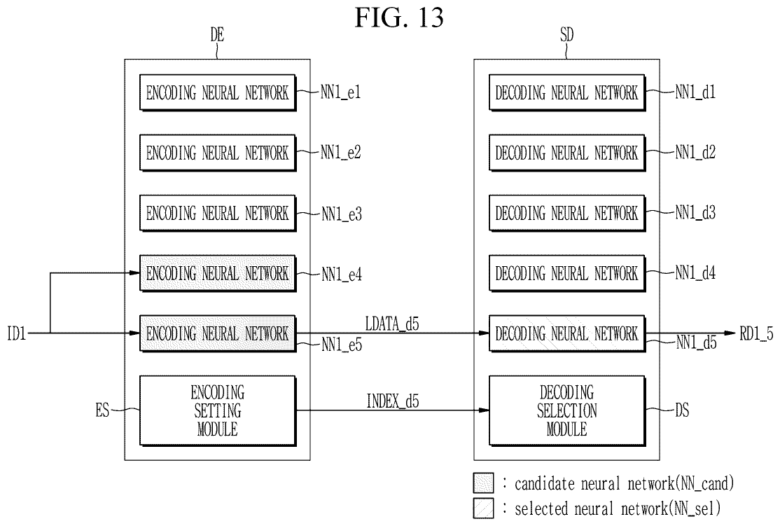

The communication device 150 may be connected to the network NT and perform communication to transmit and receive encoded latent data LDATA and index data INDEX for the latent data LDATA according to the embodiments of the present disclosure. The encoding operation for generating latent data LDATA and index data INDEX will be described later in the description of FIGS. 4 to 13.

In one or more embodiments, the communication device 150 may be a communication interface device including a wired interface, a wireless interface, a Bluetooth interface, and an optical interface, and the communication interface device may include a network interface card, a network adapter, etc.

The electronic device 10_i may be connected to the network NT through the communication device 150 and transmit and receive latent data LDATA and index data INDEX for the latent data LDATA.

In one or more embodiments, the server 20 may include a processor, a memory, a storage device, and a communication device corresponding to the processor 110, memory 120, storage device 130, and communication device 150 described in the description of FIG. 2. To facilitate description, the components included in the server 20 may be replaced with the description of the processor 110, memory 120, storage device 130, and communication device 150 of FIG. 2.

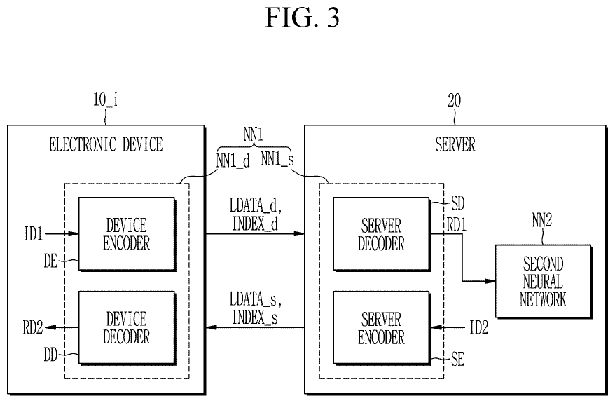

FIGS. 3 and 4 are diagrams for describing an encoder and a decoder according to one or more embodiments. FIG. 4 illustrates the correspondence between a device encoder DE and a server decoder SD of FIG. 3.

Referring to FIGS. 1 to 4, the electronic device 10_i may include a first device neural network NN1_d. The first device neural network NN1_d may perform encoding and decoding operations on data transmitted and received from the electronic device 10_i. In one or more embodiments, the first device neural network NN1_d may receive a first input data ID1 generated by the electronic device 10_i, and perform an encoding operation based on the first input data ID1 to generate a device latent data LDATA_d and a device index data INDEX_d. In one or more embodiments, the first input data ID1 may be data generated by the processor 110 executing the APP, but is not limited thereto. In one or more embodiments, the first input data ID1 may include voice, audio, language, and image data, but is not limited thereto.

In one or more embodiments, the first device neural network NN1_d may receive a server latent data LDATA_s and a server index data INDEX_s received by the electronic device 10_i, and perform a decoding operation based on the server latent data LDATA_s and the server index data INDEX_s to generate a second restored data RD2.

The server 20 may include a first server neural network NN1_s and a second neural network NN2. In one or more embodiments, the first server neural network NN1_s may form a first neural network NN1 by combining with the first device neural network NN1_d of the electronic device 10_i through the network NT. In one or more embodiments, the first neural network NN1 may include a neural network with a plurality of autoencoder structures. The first neural network NN1 may receive input data and perform encoding and decoding operations to generate restored data similar to the input data.

In one or more embodiments, the first server neural network NN1_s may perform encoding and decoding operations on data transmitted and received from the server 20. In one or more embodiments, the first server neural network NN1_s may receive a second input data ID2 generated in the server 20, and perform an encoding operation based on the second input data ID2 to generate the server latent data LDATA_s and the server index data INDEX_s. In one or more embodiments, the second input data ID2 may include an inference result generated in the second neural network NN2, but is not limited thereto.

In one or more embodiments, the first server neural network NN1_s may receive the device latent data LDATA_d and the device index data INDEX_d received by the server 20, and perform decoding operation based on the device latent data LDATA_d and the device index data INDEX_d to generate the second restored data RD2.

In one or more embodiments, the latent data LDATA may include the device latent data LDATA_d and the server latent data LDATA_s. In one or more embodiments, the index data INDEX may include the device index data INDEX_d and the server index data INDEX_s.

For ease of description, the second neural network NN2 will be described first. The second neural network NN2 may perform inference or learning operations on input photos, texts, videos, voices, music, etc., based on the first restored data RD1. In one or more embodiments, the second neural network NN2 may include one or more neural networks, and the one or more neural networks may include a convolutional neural network (CNN), a recurrent neural network (RNN), an autoencoder, a generative adversarial network (GAN), long short-term memory (LSTM), transformer, restricted boltzmann machine (RBM), deep belief network (DBN), Q network, U network, Siamese network, and the like. The neural network described above is only an example and the present disclosure is not limited thereto.

In one or more embodiments, the first device neural network NN1_d may include the device encoder DE and a device decoder DD. In one or more embodiments, the device encoder DE may perform an encoding operation on the first input data ID1 to generate the device latent data LDATA_d and the device index data INDEX_d. In one or more embodiments, the device decoder DD may receive the server latent data LDATA_s and the server index data INDEX_s, and perform a decoding operation based on the server latent data LDATA_s and the server index data INDEX_s to generate the second restored data RD2.

In one or more embodiments, the first server neural network NN1_s may include a server encoder SE and a server decoder SD. In one or more embodiments, the server encoder DE may perform an encoding operation on the second input data ID2 to generate the server latent data LDATA_s and the server index data INDEX_s. In one or more embodiments, the server decoder SD may receive the device latent data LDATA_d and the device index data INDEX_d, and perform a decoding operation based on the device latent data LDATA_d and the device index data INDEX_d to generate the first restored data RD1.

Each of the device encoder DE and the device decoder DD may correspond to the server encoder SE and the server decoder SD, respectively. For ease of description, in the description of the server encoder SE and the device decoder DD, content common to the device encoder DE and the server decoder SD may be replaced with the description of FIG. 4.

Referring to FIG. 4, the device encoder DE may include first to fifth encoding neural networks NN1_e1 to NN1_e5 and an encoding setting module ES. In one or more embodiments, each of the first to fifth encoding neural networks NN1_e1 to NN1_e5 is a different neural network, and may receive the first input data ID1 and perform an encoding operation separately. In one or more embodiments, each of the first to fifth encoding neural networks NN1_e1 to NN1_e5 may be an autoencoder encoder, but is not limited thereto. In one or more embodiments, each of the first to fifth encoding neural networks NN1_e1 to NN1_e5 may separately perform an encoding operation based on the first input data ID1, and output different first to fifth device latent data LDATA_d1-LDATA_d5. In FIG. 4, the device encoder DE is shown to include five encoding neural networks, but the number of encoding neural networks is an example for explanation and may change depending on the embodiment.

The encoding setting module ES may control the encoding operation of the device encoder DE through a setting operation that will be described later. In one or more embodiments, the encoding setting module ES may check changes in the transmission environment of the device latent data LDATA_d and adaptively perform a reset operation according to the changes.

The encoding setting module ES may set a candidate neural network that receives the first input data ID1 among the first to fifth encoding neural networks NN1_e1 to NN1_e5 according to predetermined conditions. The predetermined conditions may include information about the transmission environment of latent data, and the information may include, but is not limited to, the transmission bandwidth of the electronic device 10_i and the type of APP being executed by the processor 110. The encoding setting module ES may control the device encoder DE so that one of the first to fifth device latent data LDATA_d1 to LDATA_d5 may be provided to the server decoder SD. In one or more embodiments, the encoding setting module ES may select one of the latent data generated by the predetermined candidate neural network, and the device encoder DE may provide the selected device latent data LDATA_d to the communication device 150. In one or more embodiments, the communication device 150 may transmit one latent data selected from the first to fifth device latent data LDATA_d1 to LDATA_d5 as the device latent data LDATA_d to the server 20.

The encoding setting module ES may generate the device index data INDEX_d corresponding to device latent data LDATA_d transmitted to the server 20, and the generated device index data INDEX_d may correspond to one of the first to fifth the encoding neural networks NN1_e1 to NN1_e5. The device index data INDEX_d may be transmitted to the server 20 along with device latent data LDATA_d. In one or more embodiments, the device index data INDEX_d may be included in the header of a packet for the device latent data LDATA_d, to be transmitted to the sever 20 together with the device latent data LDATA_d. However, embodiments are limited thereto, and the device index data INDEX_d may be transmitted to the server 20 separately from the device latent data LDATA_d.

For example, when the first device latent data LDATA_d1 generated in the first encoding neural network NN1_e1 is transmitted to the server 20, the encoding setting module ES may generate the device index data INDEX_d corresponding to the first encoding neural network NN1_e1 and the first device latent data LDATA_d1. The device index data INDEX_d corresponding to the generated first device latent data LDATA_d1 may be provided to the communication device 150 and transmitted to the server 20.

In one or more embodiments of the present disclosure, the first neural network NN1_1, which includes the first encoding neural network NN1_e1 and the first decoding neural networks NN1_d1, may be trained according to a first target compression rate. The device encoder DE transmits the first device latent data LDATA_d1 and first device index data INDEX_d1 to the server decoder SD, wherein the first device index data INDEX_d1 may contain the first target compression rate. When the server decoder SD receives the first device index data INDEX_d1 along with the first device latent data LDATA_d1, the server decoder SD may identify the first decoding neural network NN1_d1 as a corresponding decoding neural network, based on the first device index data INDEX_d1 indicating the first target compression rate. Then, the server decoder SD may input the first device latent data LDATA_d1 into the first decoding neural network NN1_d1, as the first decoding neural network NN1_d1 is trained according to the first target compression rate. Alternatively or additionally, the first device index data INDEX_d1 may include a network identification number, and the server decoder SD may identify the first decoding neural network NN1_d1 as a corresponding decoding neural network based on the network identification number. The second neural network NN1_2, the third neural network NN1_3, the fourth neural network NN1_4, and the fifth neural network NN1_5 may be trained according to different compression rates, which are second to fifth compression rates, respectively. Similar to the first device index data INDEX_d1, the index data (INDEX_d2 to INDEX_d5) transmitted along with their respective latent data (LDATA_d2 to LDATA_d5) may include the second through fifth target compression rates, respectively, and/or their corresponding network identification numbers. The compression rates and network identification numbers are provided as examples, and the embodiments of the present disclosure are not limited thereto.

The server decoder SD may include first to fifth decoding neural networks NN1_d1 to NN1_d5 and a decoding selection module DS. In one or more embodiments, each of the first to fifth decoding neural networks NN1_d1 to NN1_d5 is a different neural network and may correspond to each of the first to fifth encoding neural networks NN1_e1 to NN1_e5.

In one or more embodiments, each of the first to fifth decoding neural networks NN1_d1 to NN1_d5 and each of the first to fifth encoding neural networks NN1_e1 to NN1_e5 may be combined through the network NT to form 1_1th to 1_5th neural networks NN1_1 to NN1_5, respectively. In one or more embodiments, each of the 1_1th to 1_5th neural networks NN1_1 to NN1_5 may be a neural network having an autoencoder structure. For example, the first decoding neural network NN1_d1 and the first decoding neural network NN1_d1 may be combined to form the 1_1th neural network NN1_1 having an autoencoder structure.

The first to fifth decoding neural networks NN1_d1 to NN1_d5 may receive the first to fifth device latent data LDATA_d1 to LDATA_d5, respectively, based on the device index data INDEX_d, and may perform decoding operations independently to generate 1_1th to 1_5th restored data RD1_1-RD1_5, respectively. For example, when the server 20 receives the first device latent data LDATA_d1 that includes first device index data INDEX_d1 corresponding to it, the server 20 may route the first device latent data LDATA_d1 exclusively to the first decoding neural network NN1_d1) without sending it to the other decoding neural networks NN1_d2 to NN1_d5. When the server 20 receives the second device latent data LDATA_d2 that includes second device index data INDEX_d2 corresponding to it, the server 20 may route the second device latent data LDATA_d2 exclusively to the second decoding neural network NN1_d2 without sending it to the other decoding neural networks NN1_d1 and NN1_d3 to NN1_d5. Similarly, the third to fifth decoding neural networks NN1_d3 to NN1_d5 may each receive only the corresponding third through fifth device latent data LDATA_d3 to LDATA_d5. In one or more embodiments, each of the first to fifth decoding neural networks NN1_d1 to NN1_d5 may be a decoder of an autoencoder, but is not limited thereto. In FIG. 4, the server decoder SD is shown to include five decoding neural networks, but the number of decoding neural networks may be changed corresponding to the number of encoding generation networks included in the device encoder DE.

The decoding selection module DS may select one of the first to fifth decoding neural networks NN1_d1 to NN1_d5 as a selected decoding neural network NN_sel based on the device index data INDEX_d transmitted to the server 20. One of the selected first to fifth decoding neural networks NN1_d1 to NN1_d5 may receive one of the corresponding first to fifth device latent data LDATA_d1 to LDATA_d5 to generate the first restored data RD1.

For example, when the server 20 receives the first device latent data LDATA_d1 generated from the first encoding neural network NN1_e1 and the device index data INDEX_d corresponding to the first device latent data LDATA_d1, the decoding selection module DS may select the first decoding neural network NN1_d1 as the selected decoding neural network NN_sel based on the device index data INDEX_d. The selected first decoding neural network NN1_d1 may generate a 1_1th restored data RD1_1 by performing a decoding operation based on the received first device latent data LDATA_d1.

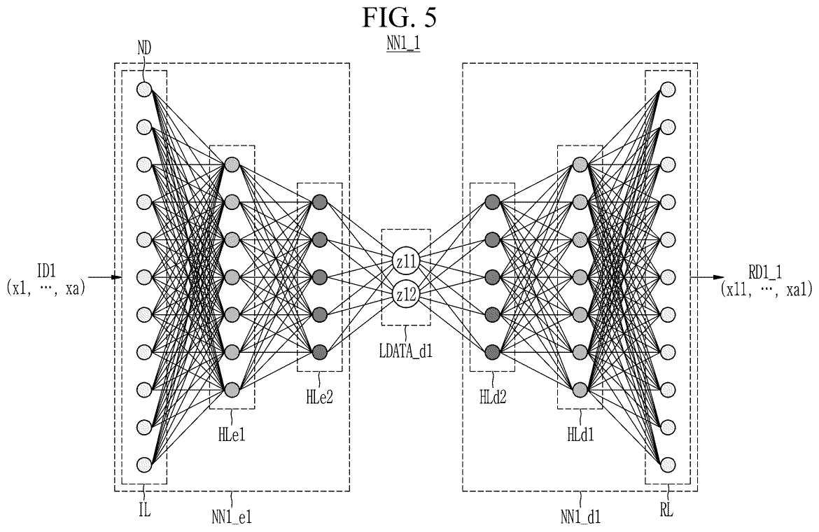

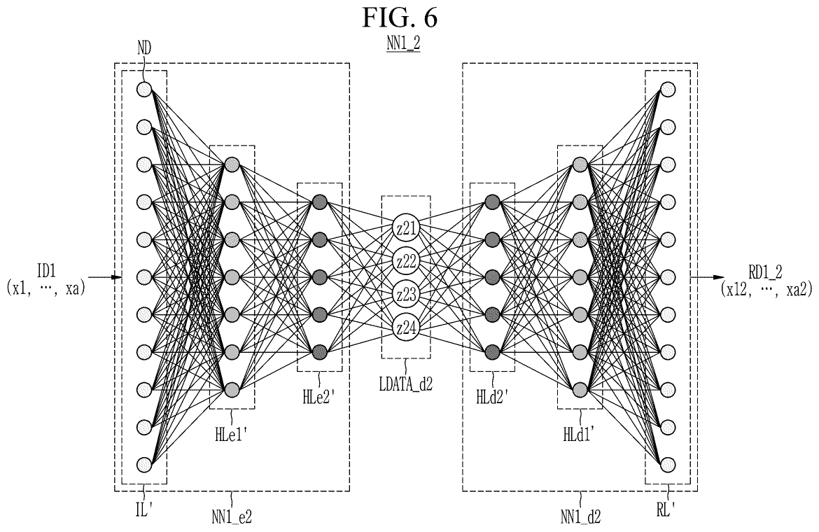

FIGS. 5 and 6 are schematic views for describing the structure of a neural network (NN) according to one or more embodiments. FIG. 5 illustrates the structure of the 1_1th neural network NN1_1 in FIG. 4, and FIG. 6 illustrates the structure of a 1_2th neural network NN1_2 in FIG. 4. For ease of description, the description of the 1_2th neural network NN1_2 will focus on the differences from the description of the 1_1th neural network NN1_1.

Referring to FIGS. 1 to 5, the 1_1th neural network NN1_1 may include at least one node ND. The nodes ND included in the 1_1th neural network NN1_1 may be connected to each other by one or more links.

In one or more embodiments, within the 1_1th neural network NN1_1, one or more nodes ND connected through a link may relatively form a relationship between an input node and an output node. The concepts of input node and output node are relative, and any node in an output node relationship with one node may be in an input node relationship with another node, and also vice versa. As described above, input node to output node relationships may be created around links. One or more output nodes may be connected to one input node through a link, and also vice versa.

In a relationship between an input node and an output node connected through one link, the value of the data of the output node may be determined based on the data input to the input node. Here, the link connecting the input node and the output node may have a weight. The weight may be variable and may be varied by the user or algorithm in order for the neural network to perform the desired function. For example, when one or more input nodes are connected to one output node by respective links, the output node may determine the output node value based on the values input in the input nodes connected to the output node and the weight set in the links corresponding to the respective input nodes.

In the 1_1th neural network NN1_1, one or more nodes ND are interconnected through one or more links to form an input node and output node relationship within the neural network. According to the number of nodes ND and links in the 1_1th neural network NN1_1, the relationship between the nodes ND and the links, and the value of the weight assigned to each of the links, the characteristics of the 1_1th neural network NN1_1 may be determined. For example, if the 1_1th neural network NN1_1 and the 1_3th neural network NN1_3 include the same number of nodes ND and links, and the weight values of the links are different, the 1_1th neural network NN1_1 and the 1_3th neural network NN1_3 may be recognized as different from each other.

The 1_1th neural network NN1_1 is a subset of a neural network, and may include an input layer IL, encoding hidden layers HLe1 and HLe2, decoding hidden layers HLd1 and HLd2, and a reconstruction layer RL. Each of the input layer IL, encoding hidden layers HLe1 and HLe2, decoding hidden layers HLd1 and HLd2, and reconstruction layer RL may include at least one node ND. The first encoding neural network NN1_e1 may include the input layer IL, and the encoding hidden layers HLe1 and HLe2. The first decoding neural network NN1_d1 may include the decoding hidden layers HLd1 and HLd2, and the reconstruction layer RL.

The nodes ND included in the input layer IL may indicate one or more node ND through which the first input data ID1 is directly input without going through a link in relationship with other nodes ND in the 1_1th neural network NN1_1. Alternatively, in the 1_1th neural network NN1_1, in the relationship between nodes based on links, the nodes ND included in the input layer IL may indicate nodes ND that do not have other input nodes connected by links.

In one or more embodiments, the nodes ND included in the reconstruction layer RL may indicate one or more nodes ND that do not have an output node in relationship with other nodes among the nodes ND in the 1_1th neural network NN1_1.

The number of nodes of the input layer IL may be the same as the number of nodes of the reconstruction layer RL. (x1, . . . , xa), which is the first input data ID1 input to the input layer IL, and (x11, . . . , xa1), which is the 1_1th restored data RD1_1 output from the reconstruction layer RL, have the same data dimension, and each element may have the same data type. For example, the data type of x1, which is an element of the first input data ID1, and the data type of x11 of the 1_1th restored data RD1_1 corresponding to x1 may be the same. The data type may be any one of a numeric type, a character type, or a set type, but examples of the data type are not limited thereto.

In one or more embodiments, the data sizes of x1 and x11 may be the same. For example, the number of bits for processing x1 and the number of bits for processing x11 may be the same.

In one or more embodiments, the number of nodes ND may decrease as the input layer IL progresses to the encoding hidden layers HLe1 and HLe2. In one or more embodiments, the second encoding hidden layer HLe2 may output the first device latent data LDATA_d1. The first device latent data LDATA_d1 may be indicated as an encoded code vector or bottleneck layer of the 1_1th neural network NN1_1. z11 and z12, which are elements of the first device latent data LDATA_d1, may be indicated as nodes of the bottleneck layer.

Referring exemplarily to FIG. 5, the first device latent data LDATA_d1 is two-dimensional data and may include z11 and z12 as elements. The data type of each z11 and z12 may be any one of numeric type, character type, and set type including integer type/real number type, etc., but examples of the above data type are not limited thereto.

In one or more embodiments, the number of nodes ND may increase as the first device latent data LDATA_d1 is input to the second decoding hidden layer HLd2 through the network NT and progresses from the decoding hidden layers HLd2 and HLd1 to the reconstruction layer RL. In one or more embodiments, the reconstruction layer RL may output the 1_1th restored data RD1_1.

In one or more embodiments, the 1_1th neural network NN1_1 may have the structure of an autoencoder, so that the number of nodes in the input layer IL may be reduced to the data dimension of the first device latent data LDATA_d1, and the data dimension of the first device latent data LDATA_d1 may be symmetrically expanded to the number of nodes in the reconstruction layer RL. In one or more embodiments, the number of nodes in each of the first and second encoding hidden layers HLe1 and HLe2 may be the same as the number of nodes in each of the first and second decoding hidden layers HLd1 and HLd2.

With additional reference to FIG. 6, the 1_2th neural network NN1_2 may include an input layer IL′, encoding hidden layers HLe1′ and HLe2′, decoding hidden layers HLd1′ and HLd2′, and a reconstruction layer RL′ corresponding to the input layer IL, the encoding hidden layers HLe1 and HLe2, the decoding hidden layers HLd1 and HLd2, and the reconstruction layer RL of FIG. 4. A second encoding neural network NN1_e2 may include the input layer IL′ and the encoding hidden layers HLe1′ and HLe2′, and a second decoding neural network NN1_d2 may include the decoding hidden layers HLd1′ and HLd2′, and the reconstruction layer RL′.

The second encoding neural network NN1_e2 may generate a second device latent data LDATA_d2 based on the first input data ID1. The second decoding neural network NN1_d2 may generate a 1_2th restored data RD1_2 based on the second device latent data LDATA_d2.

The 1_2th restored data RD1_2 output from the reconstruction layer RL′ may include elements (x12, . . . , xa2), and the first input data ID1 input to the input layer IL may include elements (x1, . . . , xa), which may have the same data dimension, and/or the same data type as the elements (x12, . . . , xa2). For example, the data type of element x1 included in the first input data ID1 may be the same as the data type of element x12 included in the 1_2th restored data RD1_2.

The second device latent data LDATA_d2 may be indicated as an encoded code vector or bottleneck layer of the 1_2th neural network NN1_2. The second device latent data LDATA_d2 may include elements z21, z22, z23 and z24, which are indicated as nodes of the bottleneck layer.

Referring exemplarily to FIG. 6, the second device latent data LDATA_d2 is four-dimensional data and may include z21, z22, z23 and z24 as elements. The data type of each z21, z22, z23 and z24 may be any one of numeric type, character type, and set type including integer type/real number type, etc., but examples of the above data type are not limited thereto.

The first device latent data LDATA_d1 and the second device latent data LDATA_d2 may be different, and the compression rate for the first input data ID1 may also be different. In one or more embodiments, the data dimension of the first device latent data LDATA_d1 and the data dimension of the second device latent data LDATA_d2 may be different from each other.

In one or more embodiments, the data type of the element of the first device latent data LDATA_d1 and the data type of the corresponding element of the second device latent data LDATA_d2 may be different from each other. For example, the data type of z21, which is an element of the second device latent data LDATA_d2, and the data type of z11, which is an element corresponding to the z21 in the first device latent data LDATA_d1, may be different.

In one or more embodiments, the data size of the element of the first device latent data LDATA_d1 and the data size of the element of the second device latent data LDATA_d2 may be different from each other. For example, the number of bits for processing the z21, which is the element of the second device latent data LDATA_d2, and the number of bits for processing the z11, which is an element corresponding to the z21 in the first device latent data LDATA_d1, may be different.

In FIGS. 5 and 6, only the structures of the 1_1th and 1_2th neural networks NN1_1 and NN1_2 among the 1_1th to 1_5th neural networks NN1_1 to NN1_5 included in the first neural network NN1 are shown, but the remaining 1_3th to 1_5th neural networks NN1_3-NN1_5 may also include autoencoder structures similar to the 1_1th and 1_2th neural networks NN1_1 and NN1_2.

In one or more embodiments, the first to fifth device latent data LDATA_d1 to LDATA_d5 output from the first to fifth encoding neural networks NN1_e1-NN1_e5 may be different from each other, and the compression rate for the first input data ID1 may also be different.

The electronic device 10_i and the server 20 may perform data communication through a plurality of different latent data, including neural networks with a plurality of autoencoder structures, through coupling through the network NT. Through communication using a plurality of different latent data, the first neural network NN1 may improve the security of data communication of the electronic system 1 by making data analysis difficult from the outside.

An existing AI model may allow electronic devices (e.g., edge devices) to process part of the AI model, transmit the results to a server, which then receives and executes the remaining tasks. However, several challenges arise with this approach. First, as AI models become more complex, the amount of data that needs to be transmitted to the server also increases, which can lead to service delays due to factors like network conditions. Additionally, there is a risk that user information could be exposed to external analysis, especially when the model server is provided by a third-party service. In the existing edge-server model, an encoder portion of a pre-trained autoencoder runs on the edge device, and the resulting latent data is transmitted over the network. However, the pre-trained autoencoder pair may have a fixed compression rate determined at the time of training, which limits the flexibility of data transmission. Moreover, since the same autoencoder structure may be used consistently in the existing AI model, the latent data generated from the same input will always be the same, increasing the risk of external analysis or malicious attacks.

The electronic system 1, according to one or more embodiments, may include multiple pairs of autoencoders, each with different model weights (e.g., different neural network parameters). These autoencoders may be trained with varying data compression rates and conversion rates. This process may allow the latent data output from the encoder side to vary, enhancing the robustness of the electronic system 1 against external malicious attacks. Furthermore, even when the latent data is output at the same compression rate, different trained autoencoders may be used to dynamically alter the latent data transmitted over the network NT. Consequently, the latent data transmitted over the network varies each time, reducing the risk of external data analysis.

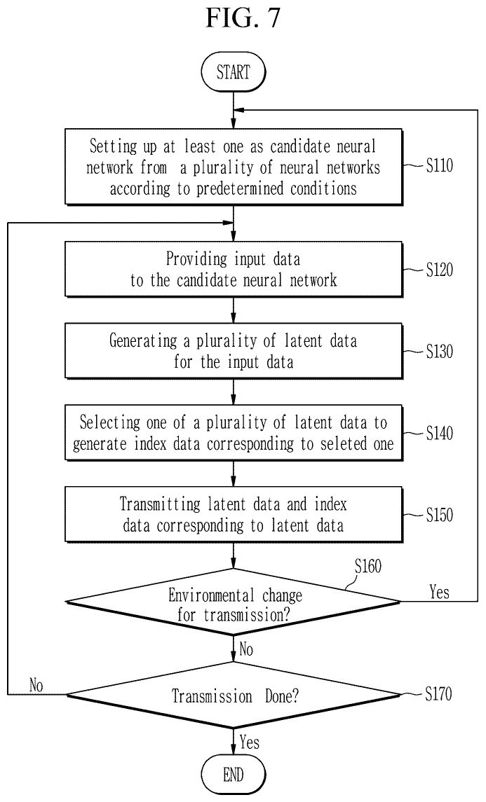

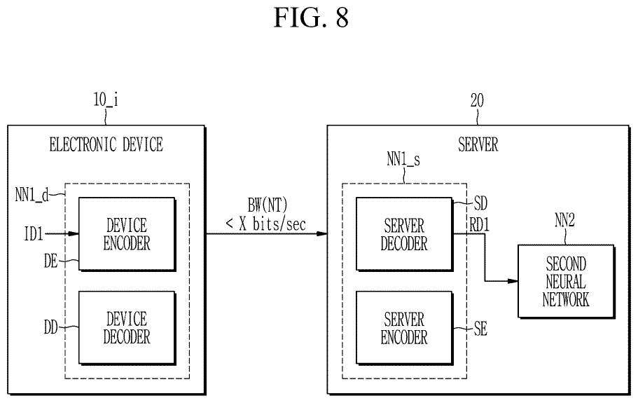

FIG. 7 is a flowchart for describing a method of operating an electronic device according to one or more embodiments. FIGS. 8 to 10 are diagrams for describing a method of operating an electronic device according to one or more embodiments.

Referring to FIGS. 1, 3, 4, and 7, the encoding setting module ES sets at least a part as a candidate neural network from a plurality of encoding neural networks according to predetermined conditions (S110).

The encoding setting module ES may set a plurality of candidate neural networks to which the first input data ID1 is received among the first to fifth encoding neural networks NN1_e1-NN1_e5, based on predetermined conditions and the data transmission environment of the electronic device 10_i.

FIGS. 8 to 10 are diagrams for describing operations performed by the electronic device 10_i and the server 20 according to an example of the predetermined conditions of step S110. Further referring to FIGS. 8 through 10 as an example, the encoding setting module ES may set a plurality of candidate neural networks NN_cand among the first to fifth encoding neural networks NN1_e1 to NN1_e5 by comparing bandwidth information input to and output from the communication device 150 to the network NT and a predetermined threshold bandwidth.

In one or more embodiments, the process 110 may be provided with information on an output bandwidth BW corresponding to the amount of data that may be output from the communication device 150 to the network NT. The encoding setting module ES may receive the output bandwidth BW and set the plurality of candidate neural networks NN_cand by comparing the output bandwidth BW with a predetermined threshold bandwidth, X bps.

Referring exemplarily to FIGS. 8 to 10, the encoding setting module ES may set the first and second encoding neural networks NN1_e1 and NN1_e2 among the first to fifth encoding neural networks NN1_e1 to NN1_e5 as the plurality of candidate neural networks NN_cand when the output bandwidth BW is less than the predetermined threshold bandwidth.

In one or more embodiments, the first and second device latent data LDATA_d1 and LDATA_d2 output from the first and second encoding neural networks NN1_e1 and NN1_e2 may have a higher compression ratio for the first input data ID1 compared to the third to fifth device latent data LDATA_d3-LDATA_d5 output from third to fifth encoding neural networks NN1_e3-NN1_e5.

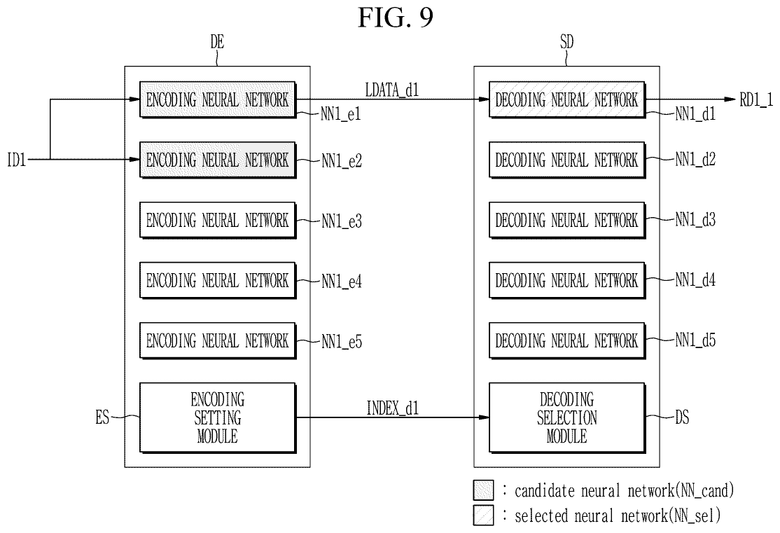

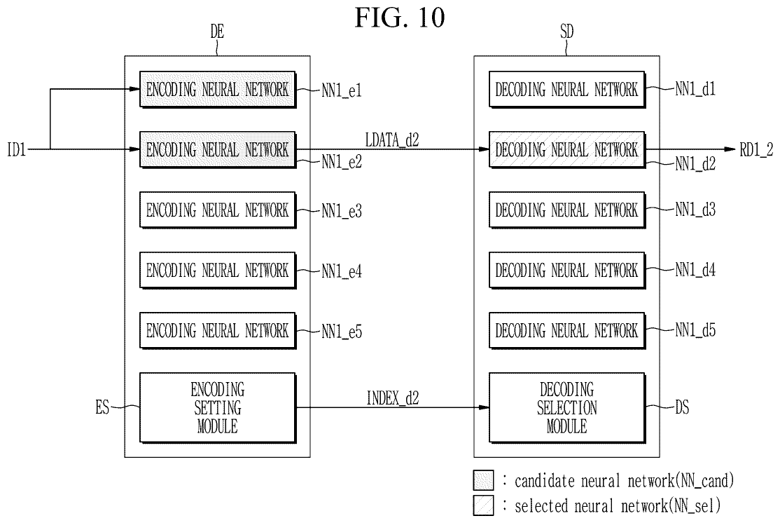

In FIGS. 9 and 10, two candidate neural networks NN_cand are shown, but the number is an example for description and may vary depending on the embodiments. When the output bandwidth BW is greater than the predetermined threshold bandwidth, the encoding setting module ES may set the first to fifth encoding neural networks NN1_e1 to NN1_e5 as the plurality of candidate neural networks NN_cand.

The encoding setting module ES provides the first input data ID1 to the plurality of candidate neural networks NN_cand (S120).

Through a setting operation of the encoding setting module ES, the first input data ID1 may be provided to the first and second encoding neural networks NN1_e1 and NN1_e2, which are the plurality of candidate neural networks NN_cand among the first to fifth encoding neural networks NN1_e1 to NN1_e5.

The plurality of candidate neural networks NN_cand perform an encoding operation on the first input data ID1 to generate a plurality of latent data (S130).

The first and second encoding neural networks NN1_e1 and NN1_e2, which are the plurality of candidate neural networks NN_cand, may perform separate encoding operations on the first input data ID1 to generate the first device latent data LDATA_d1 and second device latent data LDATA_d2, respectively.

The encoding setting module ES selects one of a plurality of latent data and generates index data corresponding to the selected latent data (S140).

In one or more embodiments, the encoding setting module ES may select one of the first device latent data LDATA_d1 and the second device latent data LDATA_d2, and generate the first device index data INDEX_d1 or the second device index data INDEX_d2 in response to the selected latent data.

The communication device 150 transmits the generated latent data and index data corresponding to the latent data (S150).

In one or more embodiments, the communication device 150 may receive latent data and index data generated in the device encoder DE, and transmit the latent data and index data to the server 20 through the network NT.

Referring to FIG. 9 as an example, the encoding setting module ES may select the first device latent data LDATA_d1 from the first device latent data LDATA_d1 and the second device latent data LDATA_d2, and may generate the first device index data INDEX_d1 in response to the first device latent data LDATA_d1.

The device encoder DE may provide the generated first device latent data LDATA_d1 and first device index data INDEX_d1 to the communication device 150, and the communication device 150 may transmit the first device latent data LDATA_d1 and the first device index data INDEX_d1 to the server 20.

Thereafter, the server 20 may receive the first device index data INDEX_d1 and the first device latent data LDATA_d1 through the communication device. The decoding selection module DS may select the first decoding neural network NN1_d1 as the selected decoding neural network NN_sel among the first to fifth decoding neural networks NN1_d1 to NN1_d5 based on the first device index data INDEX_d1, and the first decoding neural network NN1_d1 may generate the 1_1th restored data RD1_1 based on the first device latent data LDATA_d1.

Referring to FIG. 10 as an example, the encoding setting module ES may select the second device latent data LDATA_d2 from the first device latent data LDATA_d1 and the second device latent data LDATA_d2, and may generate the second device index data INDEX_d2 in response to the second device latent data LDATA_d2.

The device encoder DE may provide the generated second device latent data LDATA_d2 and second device index data INDEX_d2 to the communication device 150, and the communication device 150 may transmit the second device latent data LDATA_d2 and second device index data INDEX_d2 to the server 20.

Thereafter, the server 20 may receive the second device index data INDEX_d2 and the second device latent data LDATA_d2 through the communication device. The decoding selection module DS may select the second decoding neural network NN1_d2 among the first to fifth decoding neural networks NN1_d1 to NN1_d5 as the selected decoding neural network NN_sel based on the second device index data INDEX_d2, and the second decoding neural network NN1_d2 may generate the 1_2th restored data RD1_2 based on the second device latent data LDATA_d2.

The encoding setting module ES checks changes in the transmission environment for the device latent data LDATA_d (S160).

If the encoding setting module ES confirms that there is a change in the transmission environment, the device encoder DE may repeat steps S110 to S160.

As steps S110 to S160 are repeated several times, the encoding setting module ES may, at step S140, change the selection for the first device latent data LDATA_d1 of FIG. 9 and the selection for the second device latent data LDATA_d2 of FIG. 10. In one or more embodiments, the encoding setting module ES may alternately select the first device latent data LDATA_d1 and the second device latent data LDATA_d2. Accordingly, the communication device 150 may alternately transmit the first device latent data LDATA_d1/first device index data INDEX_d1 and the second device latent data LDATA_d2/second device index data INDEX_d2.

When the encoding setting module ES confirms that there is no change in the transmission environment, the device encoder DE checks whether the transmission operation of the device latent data LDATA_d is done (S170).

If it is confirmed that the transmission operation of the device latent data LDATA_d is not done, the device encoder DE may repeat steps S120 to S170.

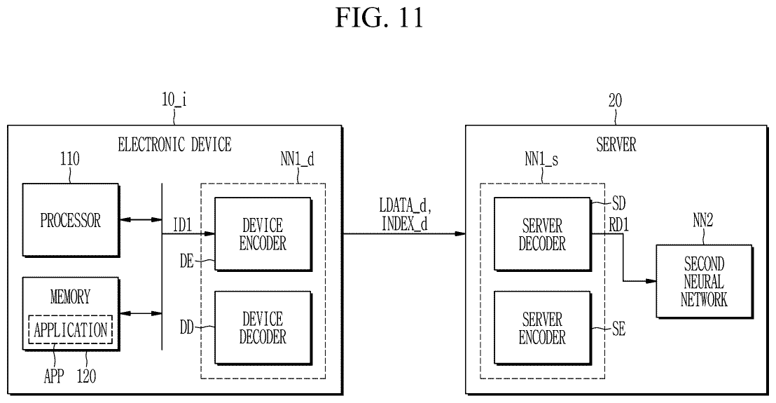

FIGS. 11 to 13 are diagrams for describing a method of operating an electronic device according to one or more embodiments. FIGS. 11 to 13 are diagrams for describing operations performed by the electronic device 10_i and the server 20 according to an example of a predetermined condition in step S110 of FIG. 7.

Referring to FIGS. 1, 3 to 4, 7, and 11 to 13, the encoding setting module ES sets or selects at least a part as a candidate neural network from a plurality of encoding neural networks according to predetermined conditions (S110).

The encoding setting module ES may set or select a plurality of candidate neural networks to which the first input data ID1 is received among the first to fifth encoding neural networks NN1_e1 to NN1_e5, based on predetermined conditions and the data transmission environment of the electronic device 10_i.

The encoding setting module ES may check information about the APP executed by the processor 110. The encoding setting module ES may set the plurality of candidate neural networks NN_cand among the first to fifth encoding neural networks NN1_e1 to NN1_e5 based on the APP running on the processor 110.

For example, the APP may request specifications of the first input data ID1 of a specific resolution or a specific refresh rate. In one or more embodiments, based on the encoding setting module ES and the running APP, the fourth and fifth encoding neural networks NN1_e4 and NN1_e5 among the first to fifth encoding neural networks NN1_e1 to NN1_e5 may be set or selected as the plurality of candidate neural network NN_cand.

In one or more embodiments, the fourth and fifth device latent data LDATA_d4 and LDATA_d5 output from the fourth and fifth encoding neural networks NN1_e4 and NN1_e5 may have a lower compression ratio for the first input data ID1 compared to the first and third device latent data LDATA_d1-LDATA_d3 output from the first and third encoding neural networks NN1_e1-NN1_e3.

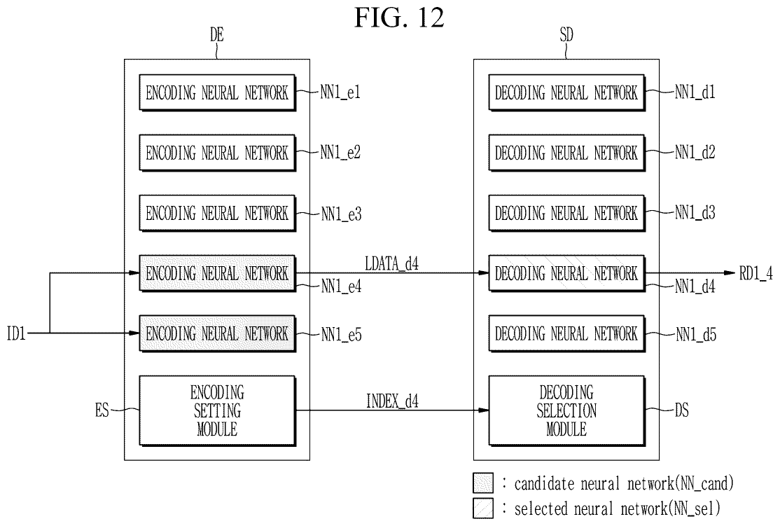

In FIGS. 11 and 12, two candidate neural networks NN_cand are shown, but the number is an example for description and may vary depending on the embodiments. Although not shown in the drawings, based on the running APP, the encoding setting module ES may set or select the first to fifth encoding neural networks NN1_e1 to NN1_e5 as the plurality of candidate neural networks NN_cand.

The encoding setting module ES provides the first input data ID1 to the plurality of candidate neural networks NN_cand (S120).

Through a setting operation of the encoding setting module ES, the first input data ID1 may be provided to the fourth and fifth encoding neural networks NN1_e4 and NN1_e5, which are the plurality of candidate neural networks NN_cand among the first to fifth encoding neural networks NN1_e1 to NN1_e5.

The plurality of candidate neural networks NN_cand perform an encoding operation on the first input data ID1 to generate a plurality of latent data (S130).

The fourth and fifth encoding neural networks NN1_e4 and NN1_e5, which are the plurality of candidate neural networks NN_cand, may perform separate encoding operations on the first input data ID1 to generate the fourth device latent data LDATA_d4 and fifth device latent data LDATA_d5, respectively.

The encoding setting module ES selects one of a plurality of latent data and generates index data corresponding to the selected latent data (S140).

In one or more embodiments, the encoding setting module ES may select one of the fourth device latent data LDATA_d4 and the fifth device latent data LDATA_d5, and generate a fourth device index data INDEX_d4 or a fifth device index data INDEX_d5 in response to the selected latent data.

The communication device 150 transmits the generated latent data and index data corresponding to the latent data (S150).

In one or more embodiments, the communication device 150 may receive latent data and index data generated in the device encoder DE, and transmit the latent data and index data to the server 20 through the network NT.

Referring to FIG. 11 as an example, the encoding setting module ES may select the fourth device latent data LDATA_d4 from the fourth device latent data LDATA_d4 and the fifth device latent data LDATA_d5, and may generate the fifth device index data INDEX_d5 in response to the fifth device latent data LDATA_d5.

The device encoder DE may provide the generated fourth device latent data LDATA_d4 and fifth device index data INDEX_d5 to the communication device 150, and the communication device 150 may transmit the fourth device latent data LDATA_d4 and fifth device index data INDEX_d5 to the server 20.

Thereafter, the server 20 may receive the fourth device index data INDEX_d4 and the fourth device latent data LDATA_d4 through the communication device. The decoding selection module DS may select a fourth decoding neural network NN1_d4 among the first to fifth decoding neural networks NN1_d1 to NN1_d5 as the selected decoding neural network NN_sel based on the fourth device index data INDEX_d4, and the fourth decoding neural network NN1_d4 may generate a 1_4th restored data RD1_4 based on the fourth device latent data LDATA_d4.

Referring to FIG. 12 as an example, the encoding setting module ES may select the fifth device latent data LDATA_d4 from the fourth device latent data LDATA_d4 and the fifth device latent data LDATA_d5, and may generate the fifth device index data INDEX_d5 in response to the fifth device latent data LDATA_d5.

The device encoder DE may provide the generated fourth device latent data LDATA_d4 and fifth device index data INDEX_d5 to the communication device 150, and the communication device 150 may transmit the fifth device latent data LDATA_d5 and fifth device index data INDEX_d5 to the server 20.

Thereafter, the server 20 may receive the fifth device index data INDEX_d5 and the fifth device latent data LDATA_d5 through the communication device. The decoding selection module DS may select a fifth decoding neural network NN1_d5 among the first to fifth decoding neural networks NN1_d1 to NN1_d5 as the selected decoding neural network NN_sel based on the fifth device index data INDEX_d5, and the fifth decoding neural network NN1_d5 may generate a 1_5th restored data RD1_5 based on the fifth device latent data LDATA_d5.

The encoding setting module ES checks changes in the transmission environment for the device latent data LDATA_d (S160).

If the encoding setting module ES confirms that there is a change in the transmission environment, the device encoder DE may repeat steps S110 to S160.

As steps S110 to S160 are repeated several times, the encoding setting module ES may, at step S140, change the selection for the fourth device latent data LDATA_d4 of FIG. 11 and the selection for the fifth device latent data LDATA_d5 of FIG. 12. In one or more embodiments, the encoding setting module ES may alternately select the fourth device latent data LDATA_d4 and the fifth device latent data LDATA_d5. Accordingly, the communication device 150 may alternately transmit the fourth device latent data LDATA_d4/fourth device index data INDEX_d4 and the fifth device latent data LDATA_d5/fifth device index data INDEX_d5.

When the encoding setting module ES confirms that there is no change in the transmission environment, the device encoder DE checks whether the transmission operation of the device latent data LDATA_d is done (S170).

If it is confirmed that the transmission operation of the device latent data LDATA_d is not done, the device encoder DE may repeat steps S120 to S170.

In one or more embodiments, the device encoder DE may perform a transmission operation in adaptive response to the data transmission environment by setting the plurality of candidate neural networks NN_cand and performing an encoding operation. With the adaptive transmission, the efficiency of the data transmission operation of the electronic device 10_i may be improved.

In one or more embodiments, the device encoder DE may set or select the plurality of candidate neural networks NN_cand and perform an encoding operation to perform transmission while varying the encoding operation for the input data. The device encoder DE may make it difficult to analyze data at an input part of the network NT or the server 20 with the transmission operation, and the electronic device 10_i may improve the security of data transmission.

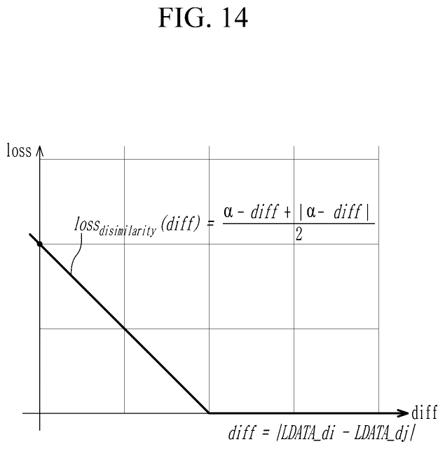

FIG. 14 is a graph for describing a loss function applied to the learning process of a neural network according to one or more embodiments.

Referring to FIGS. 2, 3, and 14, In one or more embodiments, the first neural network NN1 may be learned using unsupervised learning.

In one or more embodiments, the learning data of the first neural network NN1 may not be labeled with the correct answer. That is, for example, in the case of supervised learning on data classification, the learning data may be data in which each training data is labeled with a category.

In one or more embodiments, in the case of learning for the first neural network NN1, the error may be calculated by comparing learning data, which is the first input data ID1, with the first restored data RD1, which is output. The calculated error is back-propagated in the neural network in the reverse direction (i.e., from the reconstruction layer to the input layer), and the connection weight of each node in each layer of the neural network may be updated according to the back-propagation. The amount of change in the connection weight of each updated node may be determined according to the learning rate.

Calculation of the neural network for the first input data ID1 and back-propagation of the error may configure a learning cycle (epoch). The learning rate may be applied differently depending on the number of repetitions of the learning cycle of the neural network. For example, in the early stages of neural network learning, a high learning rate may be used to ensure that the neural network quickly achieves a certain level of performance to increase efficiency, and in the later stages of training, a low learning rate may be used to increase accuracy.

In one or more embodiments, the first neural network NN1 may be repeatedly trained in a direction to discriminate between the first to fifth device latent data LDATA_d1 to LDATA_d5 while minimizing the difference between the first input data ID1 and the first restored data RD1. In one or more embodiments, the 1_1th to 1_5th neural networks NN1_1 to NN1_5 included in the first neural network NN1 may be trained together, and may be trained in a direction to minimize the final loss function below. In one or more embodiments, the 1_1st to 1_5th neural networks NN1_1 to NN1_5 may be trained separately after forming the structure and then trained together.

In one or more embodiments, the final loss function of the first neural network NN1 may be represented by Equation 1 below.

$$loss ( NN 1 ) = {\sum }_{i = 1}^{5} {loss}_{reconstruction} ( ID 1 , RD {1}_{i} ) + {\sum }_{i = 1}^{5} {\sum }_{j = i + 1}^{5} {loss}_{disimilarity} ( \vert LDATA\_di - LDATA\_dj \vert ) \qquad ( Equation 1 )$$

In Equation 1, loss(NN1) is the final loss function of the first neural network NN1, loss_{reconstruction} is the reconstruction loss function, ID1 is the first input data ID1 input to the first neural network NN1, RD1ᵢ is an (i)th reconstruction data RD_i of an (i)th neural network NN1_i, loss_{disimilarity} is the difference loss function, LDATA_di is an (i)th device latent data LDATA_di output from an (i)th encoding neural network NN1_ei, and LDATA_dj is a (j)th device latent data LDATA_dj output from a (j)th encoding neural network NN1_ej.

The reconstruction loss function may be a loss function for learning to strengthen the resilience of the first neural network NN1. In one or more embodiments, the reconstruction loss function may be a mean squared error (MSE) function, a root mean squared error (RMSE) function, etc., but is not limited thereto.

The difference loss function may be a loss function for distinguishing between the first to fifth device latent data LDATA_d1 to LDATA_d5 output from the first to fifth encoding neural networks NN1_e1 to NN1_e5 in the first neural network NN1. Referring to FIG. 14 as an example, the difference loss function may be represented by Equation 2 below.

$${loss}_{disimilarity} ( diff ) = \frac{a - diff + \vert a - diff \vert}{2} , diff = \vert LDATA\_di - LDATA\_dj \vert \qquad ( Equation 2 )$$

In Equation 2, loss_{disimilarity}(diff) is the difference loss function, diff is the size of the difference between the (i)th device latent data LDATA_di of the (i)th encoding neural network NN1_ei and the (j)th device latent data LDATA_dj of the (j)th encoding neural network NN1_ej, and a is a predetermined coefficient.

In one or more embodiments, in order to obtain the diff, the difference between the corresponding elements between the (i)th device latent data LDATA_di and the (j)th device latent data LDATA_dj may be obtained. In one or more embodiments, if there is no corresponding element between the (i)th device latent data LDATA_di and the (j)th device latent data LDATA_dj, the difference between the elements may be replaced with a predetermined constant. In one or more embodiments, the diff may be a size obtained through the difference between the elements.

In one or more embodiments, the a may be a reference value for distinguishing between the (i)th device latent data LDATA_di and the (j)th device latent data LDATA_dj, and is a positive real number greater than or equal to 0. In one or more embodiments, the a may be changed. In one or more embodiments, if the diff is greater than the a, a distinction may be made between the (i)th device latent data LDATA_di and the (j)th device latent data LDATA_dj.

Through the above learning, the first neural network NN1 may have a plurality of neural networks that have a certain level of similar resilience and output different latent data. Including the plurality of neural networks as described above, the first neural network NN1 may improve the security of data transmission and adaptively respond to the data transmission environment.

While the embodiments of the present disclosure have been described in detail, it is to be understood that the disclosure is not limited to the disclosed embodiments, but on the contrary, is intended to cover various modifications and equivalent arrangements included within the spirit and scope of the appended claims.

What is claimed is:

1. An electronic device, comprising:
at least one processor configured to:
receive an input data and perform an encoding operation based on the input data to generate a first latent data, through a first neural network;
perform an encoding operation based on the input data to generate a second latent data different from the first latent data, through a second neural network different from the first neural network; and
generate an index data corresponding to one of the first latent data and the second latent data; and
a communication device configured to transmit the index data and one of the first latent data and the second latent data corresponding to the index data to an external destination.

2. The electronic device as claimed in claim 1, wherein each of the first neural network and the second neural network is an encoder that constitutes an autoencoder, the autoencoder comprising the encoder and a decoder.

3. The electronic device as claimed in claim 1, wherein the at least one processor is further configured to:
perform an encoding operation using a third neural network different from the first neural network and the second neural network; and
perform a setting operation for at least part of the first to third neural networks to provide the input data to the first and second neural networks and not to provide the input data to the third neural network.

4. The electronic device as claimed in claim 3, wherein the setting operation is performed based on a bandwidth of data input and output from the communication device.

5. The electronic device as claimed in claim 1, the index data comprises a first index data corresponding to the first latent data, and a second index data corresponding to the second latent data,
wherein the at least one processor is further configured to:
determine a transmission environment of the electronic device at a first transmission time;
select the first neural network based on the transmission environment to generate the first latent data, and transmit the first latent data and the first index data to the external destination while omitting a transmission of the second latent data and the second index data;
detect a change in the transmission environment of the electronic device and determine a changed transmission environment at a second transmission time; and
select the second neural network based on the changed transmission environment to generate the second latent data and the second index data, and transmit the second latent data and the second index data to the external destination while omitting a transmission of the first latent data and the first index data.

6. The electronic device as claimed in claim 1, wherein dimensions of the first latent data are different from dimensions of the second latent data.

7. The electronic device as claimed in claim 1, wherein the first latent data comprises a first element,
wherein the second latent data comprises a second element corresponding to the first element, and
wherein a data type of the first element is different from a data type of the second element.

8. The electronic device as claimed in claim 1, wherein the index data comprises a first index data corresponding to the first latent data, and a second index data corresponding to the second latent data, and
wherein the communication device is configured to omit a transmission of the second index data when the first index data is transmitted.

9. The electronic device as claimed in claim 8, wherein the communication device is alternately configured to transmit the first index data and the second index data.

10. An electronic device, comprising:
a communication device configured to receive a latent data and an index data corresponding to the latent data; and
at least one processor configured to:
perform a decoding operation on the latent data to output restored data, through a plurality of neural networks that are different from each other; and
select one of the plurality of neural networks based on the index data.

11. The electronic device as claimed in claim 10, wherein the plurality of neural networks comprise a first neural network and a second neural network that are different from each other, and
wherein each of the first neural network and the second neural network a decoder that constitutes an autoencoder, the autoencoder comprising an encoder and the decoder.

12. The electronic device as claimed in claim 11, wherein the index data comprises a first index data indicating a first compression rate corresponding to the first neural network and a second index data indicating a second compression rate corresponding to the second neural network, and
the second index data is not received by the communication device when the communication device receives the first index data.

13. The electronic device as claimed in claim 12, wherein in response to receiving the first index data, and
wherein the at least one processor is further configured to perform a selection operation for the first neural network and the latent data is provided to the first neural network.

14. The electronic device as claimed in claim 11, further comprising:
another neural network configured to receive the restored data and perform an inference operation based on the restored data.

15. A method of operating an electronic device, the method comprising:
selecting a plurality of candidate neural networks from a plurality of neural networks according to predetermined conditions;
providing input data to the plurality of candidate neural networks;
generating a plurality of latent data for the input data based on the plurality of candidate neural networks;
generating index data corresponding to one of the plurality of latent data; and
transmitting the index data and one of the plurality of latent data corresponding to the index data to an external destination.

16. The method of operating the electronic device as claimed in claim 15, wherein
the plurality of neural networks are encoders of an autoencoder, the autoencoder comprising the encoders and decoders.

17. The method of operating the electronic device as claimed in claim 15, wherein the predetermined condition comprises information on a type of program configured to generate the input data or bandwidth in external transmission.

18. The method of operating the electronic device as claimed in claim 15, further comprising:
after the transmitting the index data and the one of the plurality of latent data,
detecting a change in a transmission environment of the plurality of latent data.

19. The method of operating the electronic device as claimed in claim 18, further comprising:
selecting another plurality of candidate neural networks from the plurality of neural networks according to the predetermined conditions, based on the change in the transmission environment.

20. The method of operating the electronic device as claimed in claim 15, wherein the plurality of candidate neural networks comprise first and second neural networks different from each other,
wherein the plurality of latent data comprises a first latent data generated by the first neural network and a second latent data generated by the second neural network, and
wherein dimensions of the first latent data are different from the dimensions of the second latent data.
